(19) United States
(12) Patent Application Publication
(10) Pub. No.: US 2005/0112485 A1
(43) Pub. Date: May 26, 2005

(54) Fabrication method of liquid crystal display device using color filter substrate formed using back exposure

(75) Inventors: Dong-Hoon Lee, Gyungsangbuk-Do (KR); Byoung-Ho Lim, Gyungsangbuk-Do (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 10/968,408

(22) Filed: Oct. 19, 2004

(30) Foreign Application Priority Data
Nov. 24, 2003 (KR) 83771/2003

(51) Int. Cl. G03G 15/04

(52) U.S. Cl. 430/64; 503/202; 503/226; 430/36; 430/103; 430/105

(57) ABSTRACT

A method for fabricating a color filter substrate in a liquid crystal display is disclosed. A color filter layer is formed on a substrate. First and second organic layers containing an ultraviolet light absorbent are formed on the substrate. The first and second organic layers are exposed from the front and back of the substrate and then developed to form a spacer and a black matrix. An alignment layer is formed on the developed first and second organic layers. A common electrode may be formed between the color filter layer and the first and second organic layers.

### PRIORITY CLAIM

This application claims the benefit of Korean Application No. P2003-83771, filed on Nov. 24, 2003, which is hereby incorporated by reference as if fully set forth herein.

### BACKGROUND

1. Field

The present invention relates to a fabrication method of a liquid crystal display device, and more particularly, to a method for fabricating a color filter substrate, using a small number of masks.

2. Description of the Related Art

A liquid crystal display (LCD) device displays an image using a liquid crystal driven according to an applied signal. The LCD includes an upper substrate and a lower substrate.

In general, the upper substrate is a color filter substrate for displaying an image in color, and the lower substrate is a TFT array substrate on which unit pixels are arranged in a matrix configuration.

A structure of an LCD panel comprising the upper substrate 150 and the lower substrate 100 will now be described with reference to FIG. 1.

As shown in FIG. 1, a plurality of gate lines 101 are arranged parallel to one another on the lower substrate 100. In addition, a plurality of data lines 102 are arranged parallel to one another and perpendicularly to the gate lines 101 on the lower substrate 100. Unit pixel regions are defined by intersection of the gate lines 101 and the data lines 102, and the defined unit pixels are arranged on a TFT array substrate in a matrix configuration.

In addition, a switching device 103 for driving the unit pixel is formed at every intersection of the gate lines 101 and the data lines 102.

A thin film transistor (TFT) is commonly used as a switching device, and includes a gate electrode, a source electrode, a drain electrode and a channel layer. Each gate electrode is connected to a gate line 101, and each source electrode is connected to a data line 102.

In addition, pixel electrodes 104 for applying an electric field to a liquid crystal 110 are formed on the lower substrate 100, and an alignment layer (not shown) for an initial alignment of the liquid crystal 110 is formed on the pixel electrode 104 over an entire surface of the lower substrate 100. An organic layer such as polyimide is commonly used as the alignment layer, and an alignment of the liquid crystal is prepared through a rubbing process in which the alignment layer is rubbed with a rubbing cloth or the like after having been applied to the lower substrate 100.

In addition, spacers (not shown) for maintaining a uniform cell gap between the attached lower substrate 100 and upper substrate 150 are scattered on the alignment layer.

Also, a sealant (not shown) is formed along an outer edge of a pixel region of the lower substrate 100 in order to attach the upper substrate and the lower substrate and prevent leakage of an injected liquid crystal.

Next, a structure of an upper substrate 150 for displaying an image in color will now be described.

A black matrix 151 for shielding unnecessary light of light proceeding from the lower substrate 100 is formed as a matrix type on the upper substrate 150, and a color filter for displaying an image in color is formed on the black matrix. In general, red, green and blue (R, G and B) sub-color filters 152 are formed as one group for each unit pixel.

An overcoat layer 153 for compensating a step difference of the color filter layer may be formed on the color filter layer.

A common electrode 154 for applying an electric field to a liquid crystal together with the pixel electrode 104 of the lower substrate 100 is formed on the overcoat layer 153, and an alignment layer (not shown) for an initial alignment of the liquid crystal is formed on the common electrode 154. Spacers (not shown) for maintaining a cell-gap between the upper substrate 150 and the lower substrate 100 after attachment may be formed on the alignment layer. The spacers may be formed on one of the upper substrate 150 and the lower substrate 100.

A structure of a color filter substrate, an upper substrate of an LCD device, will now be briefly described with reference to FIG. 2.

As for the color filter substrate, a black matrix 202 is formed on a substrate made of a transparent material. The black matrix 202 may be an opaque metallic thin film or a chemical resin which cuts off unwanted light proceeding from the TFT array substrate, the lower substrate of the LCD device.

The black matrix 202 is formed as a matrix type, corresponding to the gate lines arranged in a longitudinal direction and the data lines arranged in a horizontal direction. A color resin for displaying an image in color is formed at each pixel region defined by the black matrix. There are R, G and B color resins, and the R, G and B color resins are formed as one group for each unit pixel.

In addition, to compensate a step difference of the color filter layer and protect the color filter layer, a transparent overcoat layer 204 is further formed on the color filter layer 203.

A common electrode 205, a transparent electrode for applying an electric field to a liquid crystal, is further formed on the overcoat layer 204, and spacers 206 for maintaining a cell-gap of the LCD device are formed on the common electrode 205.

In addition, an alignment layer 207 for an initial alignment of the liquid crystal injected between the color filter substrate and the TFT array substrate is further formed on the spacer 206.

Next, a fabrication process of the color filter substrate of the LCD device adopting such a structure will now be briefly described with reference to FIGS. 3A to 3D.

First, a layer for forming a black matrix made of a metallic material or a resin material is formed on a transparent substrate.

In general, the black matrix is formed between the R, G and B sub-color filters in order to cut off light passing through a reverse tilt domain formed around the pixel electrode of the lower TFT array.

In general, a metallic thin film of chrome (Cr) or the like, an optical density of which is greater than 3.5, or an organic material such as carbon or the like is mainly used as the black matrix. To achieve low reflection, double layers such as chrome/chrome oxide (Cr/CrOₓ) may be used as the black matrix.

If the metallic thin film is used as the black matrix, the pattern may be formed on the metallic thin film by photolithography, and if a resin made of a photosensitive organic material is used as the black matrix, the pattern may be formed on the resin by an exposure process and a development process.

FIG. 3A shows a black matrix 202 having a pattern and formed on a substrate 201. In order to form the black matrix on the substrate, a first mask including a pattern for forming a black matrix is required.

After the black matrix has been formed 202, as shown in FIG. 3B, a color filter layer 203 including R, G and B sub-color filters for displaying an image in color is formed.

The color filter may be fabricated by various methods such as a dyeing method, an electrodepositing method, a pigment dispersing method, a printing method or the like. As one example, a process for fabricating a color filter by the pigment dispersing method will now be described.

First, one of R, G and B color resins is applied on an entire surface of the substrate 201 on which the black matrix 202 has been formed (herein, the color resins are applied in order of R, G and B, and the applying order of the color resin can be set randomly). Then, exposure is selectively performed on the applied R color resin, thereby forming an R sub-color filter layer 203 at a desired region.

Then, the G color resin is applied on the substrate on which the R sub-color filter layer has been formed, and selective exposure is performed on the applied G color resin, thereby patterning a G sub-color filter layer 203 at a corresponding region. The same process is performed on the B color resin, thereby forming a B sub-color filter layer 203. That is, when the color filter layer is formed, an exposure process is repeatedly performed using a second mask.

That is, in order to form the R, G and B sub-color filters, a mask process including exposure and development, and a cleaning are performed three times.

After the color filter layer 203 has been formed, as shown in FIG. 3C, a transparent overcoat layer 204 of an organic component is formed in order to compensate a step difference of the color filter layer.

After the overcoat layer 204 has been formed, an ITO (Indium Tin Oxide) film 205, a transparent electrode for applying an electric field to a liquid crystal layer is further formed. The ITO film operates as a common electrode 205.

Spacers 206 are formed on the common electrode 205 to maintain a uniform cell-gap of the LCD device. In order to form the spacer, a scattering method in which ball type spacers are scattered or a patterning method in which a size, a height and a position of the spacer can be determined may be used.

The scattering method may be divided into a wet scattering method in which spacers are mixed with alcohol or the like and then scattered and a dry scattering method in which only spacers are scattered. The dry scattering method uses static electricity or a nonelectrostatic scattering method uses air pressure. The nonelectrostatic scattering method is commonly used for a liquid crystal cell structure which is vulnerable to static electricity.

However, in the scattering method, the position and the height of the scattered spacer cannot be determined. Therefore, a column spacer formation method may be used. The column spacer formation method can increase an aperture ratio.

In the column spacer formation method, a photosensitive resin for forming spacers is applied on the common electrode, an exposure process is performed on the applied resin by using a mask, and then a development and a cleaning are performed thereon, thereby forming the pattern. At this time, a mask process is further required.

After the spacer has been formed on the common electrode, an alignment layer is formed by depositing an organic layer made of polyimide or the like and rubbing the organic layer in a certain direction.

As a result of such processes, the color filter substrate of the LCD device is completed.

However, when the color filter substrate according to the related art is fabricated, many mask processes are required, which causes process delay and a decrease in productivity. Also, in each mask process, a series of processes such as a photoresist film deposition process, an exposure process, a cleaning process and the like are performed. For this reason, by reducing one mask process, productivity may be greatly improved and fabrication costs of the LCD device may be remarkably reduced.

### SUMMARY

By way of introduction only, a fabrication method of a color filter substrate in one aspect of the invention comprises: forming a color filter layer on a substrate; forming a first organic layer and a second organic layer on the substrate; performing front exposure and back exposure of the first and second organic layers on the substrate; and forming a spacer and a black matrix by developing the exposed organic layers.

In another embodiment, the fabrication method includes forming a plurality of photosensitive layers on the substrate; exposing the photosensitive layers to light from opposing sides of the substrate; and developing the photosensitive layers after exposing the photosensitive layers.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a schematic perspective view showing a structure of an LCD device according to the related art;

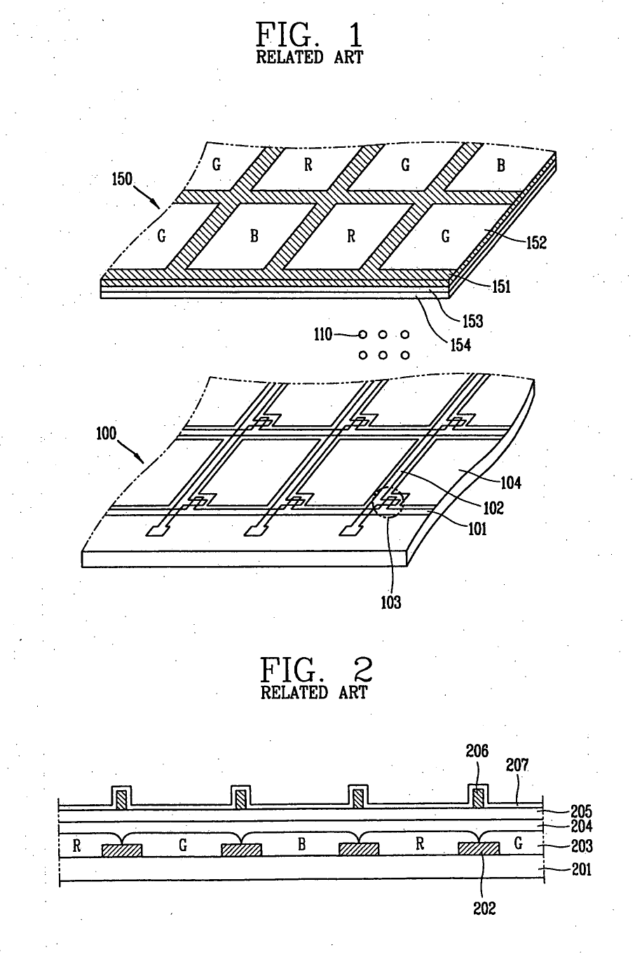

FIG. 2 is a sectional view showing a structure of a color filter substrate according to the related art;

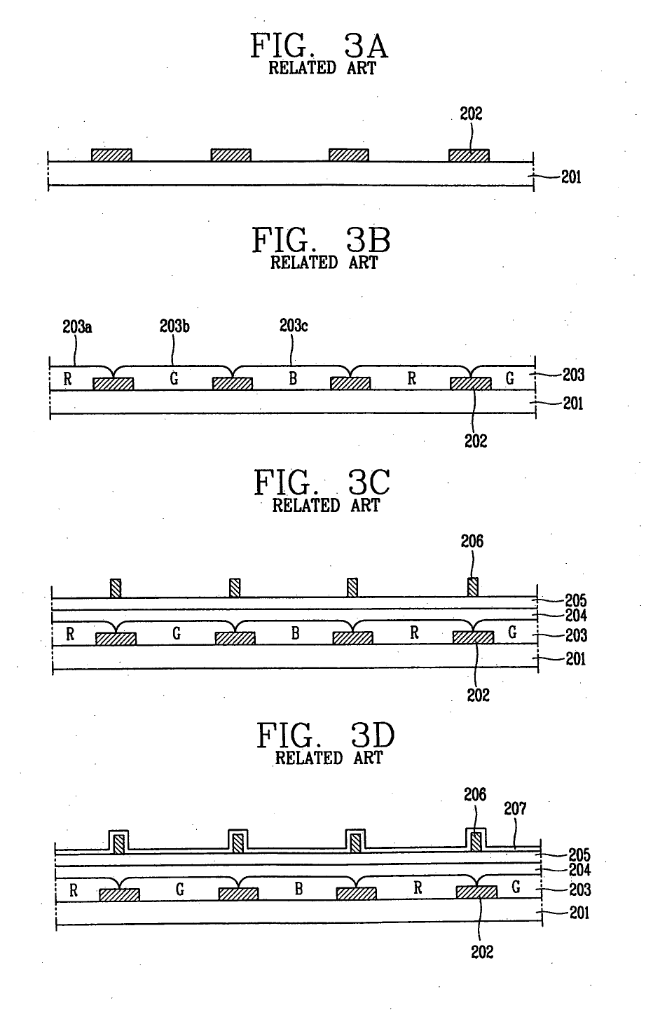

FIGS. 3A to 3B show a sequential process for fabricating a color filter substrate according to the related art;

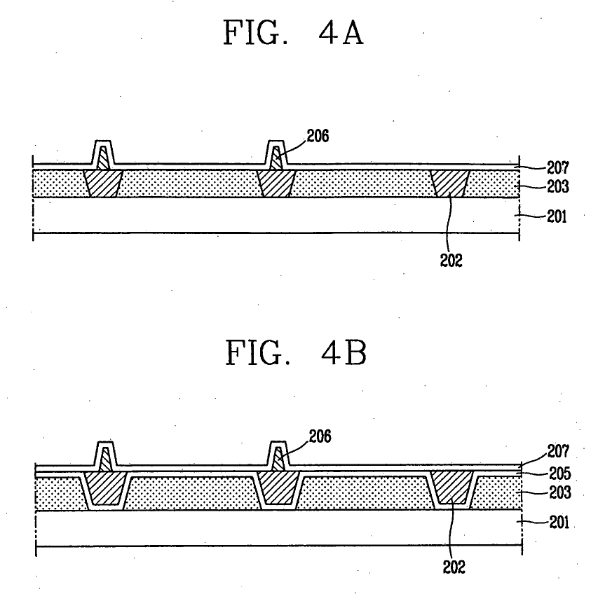

FIGS. 4A to 4B are sectional views showing a structure of a color filter substrate according to an embodiment of the present invention;

FIGS. 5A to 5E show a sequential process for forming a color filter substrate according to one embodiment of the present invention; and

FIGS. 6A and 6B are plan views showing a color filter layer according to one embodiment of the present invention.

### DETAILED DESCRIPTION

Reference will now be made in detail to embodiments of the present invention, examples of which are illustrated in the accompanying drawings.

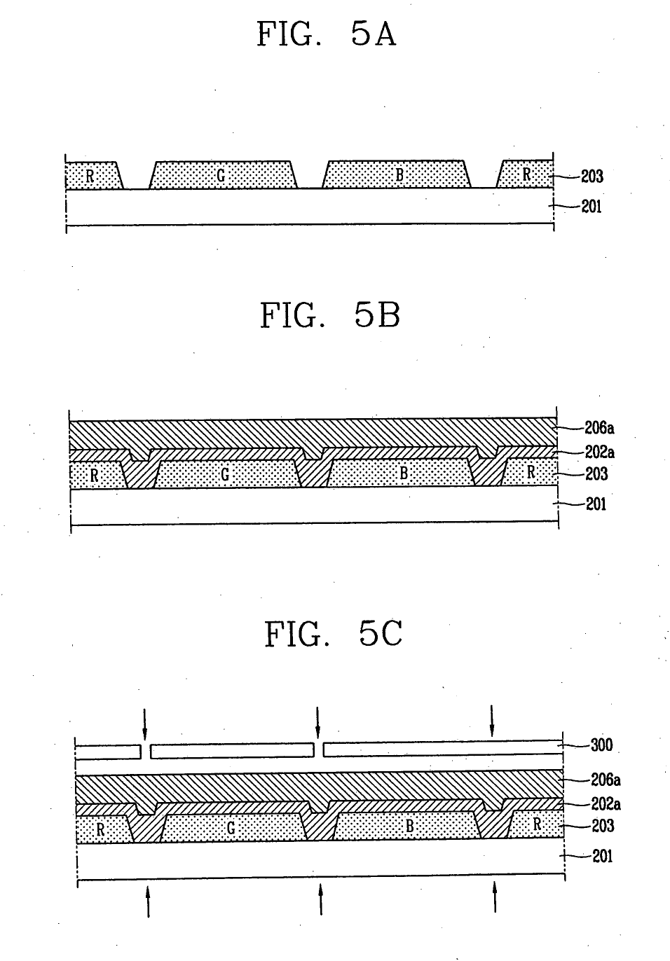

A structure of a color filter substrate and its fabrication method will now be described with reference to FIGS. 4A to 6B.

FIGS. 4A and 4B are a sectional view showing a structure of a color filter substrate in accordance with one embodiment of the present invention. FIG. 4A is a sectional view showing a structure of a color filter substrate of an in plane switching (IPS) mode LCD device, and FIG. 4B is a sectional view of a structure of a color filter substrate of a twisted nematic (TN) mode LCD device.

In FIG. 4, a color filter substrate according to one embodiment of the present invention includes a transparent substrate 201; color filter layers 203 formed on the substrate 201; a black matrix 202 formed between the color filter layers 203; spacers 206 formed on the color filter layer 203 or the black matrix 202; and an alignment layer 207 formed on the spacers 206.

In the IPS mode LCD device, a common electrode and a pixel electrode for applying an electric field to a liquid crystal are all formed on a TFT array substrate in order to improve a viewing angle of the LCD device.

However, the IPS mode LCD device is very sensitive to a change in the electric field, and thus may cause a change in image quality even if the electric field changes by a small amount. To protect the substrate from static electricity from the outside, an indium tin oxide (ITO) layer may be formed at a back surface or an inner surface of the substrate and then the color filter is formed.

As another embodiment of the present invention, a sectional view of a structure of a color filter substrate in a TN mode LCD device in which a common electrode for applying an electric field to a liquid crystal is formed on the color filter substrate will now be described through FIG. 4B. In FIG. 4B, the color filter substrate includes a transparent substrate 201; color filter layers 203 formed on the substrate 201; a common electrode 205 formed on the color filter layers; a black matrix 202 formed between the color filter layers 203; spacers 206 formed on the color filter layer 203 or the black matrix 202; and an alignment layer 207. That is, the TN mode color filter substrate contains the common electrode formed on the color filter layer.

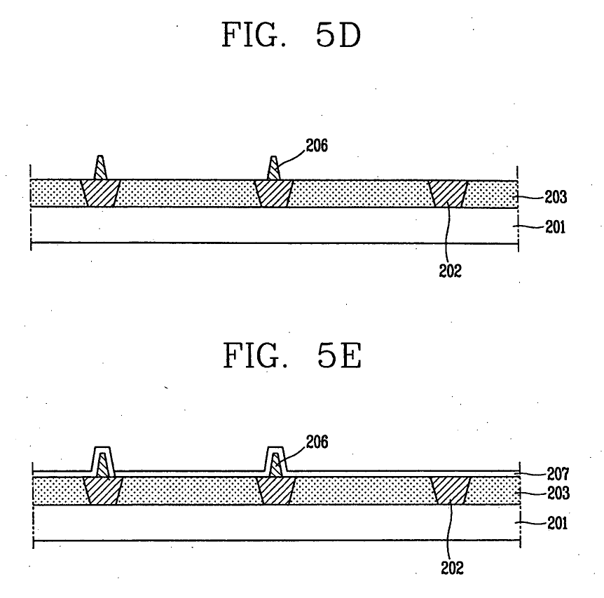

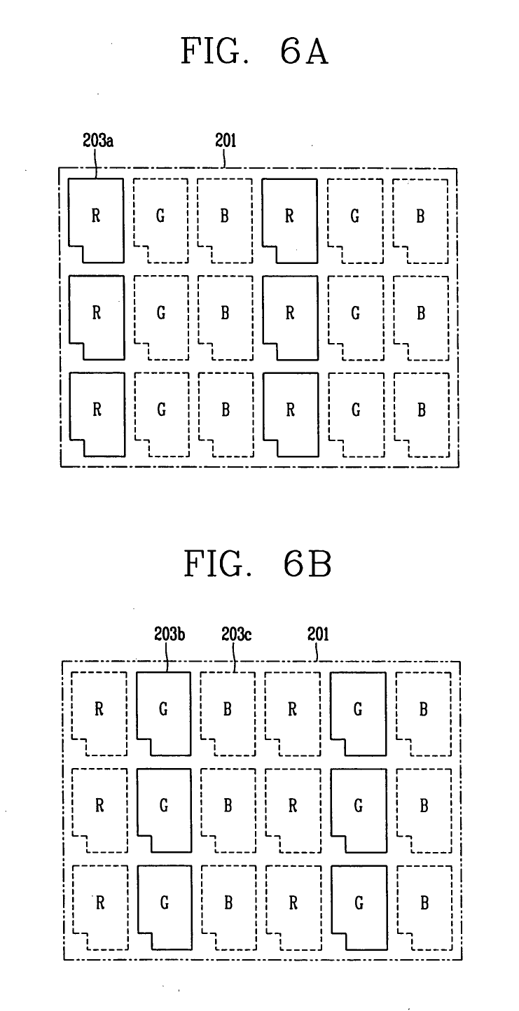

Hereafter, a fabrication process of a color filter substrate of an IPS mode LCD device according to one embodiment of the present invention will now be described with reference to FIGS. 5A to 5E and FIGS. 6A and 6B.

As shown in FIG. 5A, a color filter layer 203 is formed on a transparent substrate.

In the present embodiment, a method for forming a color filter layer by a pigment dispersing method by which a sub-color filter layer may be formed precisely will be described.

The color filter layer contains R, G and B sub-color filter layers. A photoresist organic layer is used as the sub-color filter layer. First, an R sub-color filter layer 203a is applied onto an entire surface of the substrate 201 by a coating method or the like, and then, an exposure process is performed using a mask (not shown) having a pattern. A negative type photoresist which is hardened when exposed is used as the photoresist sub-color filter layer.

As shown in FIG. 6A, which is a plan view showing that R sub-color filters are formed, as a result of an exposure process and a development process, the R sub-color filters 203a having the pattern are formed on the substrate 201. The sub-color filters are respectively formed at an island type unit pixel in which sub-color filters are separated from each other. The island type R sub-color filters may be formed using a mask.

Next, a G sub-color filter layer 203b is formed on an entire surface of the substrate on which the R sub-color filter layers have been formed, and passes through an exposure process using a mask and a development process, thereby forming G sub-color filters 203b. As the mask used to form the G sub-color filter, the mask used to form the R sub-color filter may be used if a pattern of the G sub-color filter is the same as that of the R sub-color filter, or a new mask may be used. The G sub-color filter layer 203b is also formed of a negative type photoresist resin which is hardened when exposed. The G sub-filters 203b are also formed in an island type in which the sub-color filters, which are respectively formed at pixels, are separated from each other.

After the G sub-color filters have been formed, B sub-color filters 203c are formed by the same method as that of the R and G sub-color filter layers.

Although the color filter layer is formed as the same colored sub-color filters are arranged in a vertical direction as shown in FIGS. 6A and 6B, the R, G and B sub-color filters may be arranged by a predetermined method by which the R, G and B sub-color filters are formed as one group.

As the result of the method of forming the color filter, the island type sub-color filters are formed on the substrate such that they are separated from each other. An ultraviolet light absorbent is also included in the color filter layer so that the ultraviolet light is not transmitted therethrough.

Next, as shown in FIG. 5B, a photosensitive first organic layer 202a and a photosensitive second organic layer 206a are successively formed on the substrate on which the color filter layer has been formed. The first organic layer 202a is used to form a black matrix, and the second organic layer 206a is used to form a spacer. Both the first organic layer 202a and the second organic layer 206a are negative type photosensitive organic layers which are hardened when light is irradiated thereto.

In addition, an opaque organic layer is used as the first organic layer 202 because the first organic layer 202 cuts off unnecessary light proceeding from a TFT array substrate. A transparent organic layer is used as the second organic layer 206 for a spacer. The spacer maintains a cell-gap between the upper substrate and the lower substrate.

Next, as shown in FIG. 5C, a mask 300 including a pattern for forming a spacer is disposed on the second organic layer, and exposure is performed on a front and a back of the color filter substrate. The exposure may be performed on the front and the back of the color filter substrate simultaneously or separately.

Because the aperture may be decreased if a spacer is formed on the color filter layer, the mask 300 preferably includes a pattern which forms the spacer on the black matrix.

Ultraviolet light is irradiated onto the second organic layer 206a through the mask 300, and, simultaneously or separately, the ultraviolet light is irradiated onto the first organic layer from the back of the color filter substrate.

When the ultraviolet light is irradiated onto the first organic layer, that is, when the color filter substrate is back exposed, the R, G and B sub-color filters including the ultraviolet light absorbent operate as an ultraviolet light cutoff mask, so that the ultraviolet light is not irradiated to the black matrix on the sub-color filter layers. Accordingly, the black matrix between the sub-color filter layers is hardened by the back exposure thus to remain after development.

After the front exposure and the back exposure have been made, the first organic layer 202a and the second organic layer 206a are removed in a developing solution, thereby forming a black matrix pattern and a spacer pattern.

Accordingly, the black matrix is formed only between the sub-color filter layers, and the spacer is formed at a predetermined position on the black matrix.

The process of forming the column spacer through the exposure process and the development process is advantageous in that the spacer may be formed at a desired position, and density, size and height of the spacer may be set arbitrarily. Especially, by forming the column spacer avoiding the pixel region, an aperture ratio of the color filter substrate may be improved.

FIG. 5D shows the black matrix 202 and the spacer 206 thereon, which are formed through the exposure and development processes.

Next, as shown in FIG. 5E, an alignment layer 207 for an initial alignment of a liquid crystal is applied on the substrate on which the spacer 206 has been formed.

After the alignment layer 207 has been applied, a rubbing process in which the alignment layer is rubbed with a rubbing cloth or the like in a particular direction is performed, thereby completing the alignment layer formation process.

As a result of such processes, the color filter substrate is completed. Then, the completed color filter substrate is attached to a TFT array substrate completed through a separate process using an attaching process, and the attached substrates pass through a cutting process and a liquid crystal injection process, thereby completing the LCD panel.

As another embodiment of the present invention, when a TN mode color filter substrate is fabricated, a process for forming a common electrode on the substrate on which the color filter has been formed is added. That is, unlike the process for fabricating the IPS mode color filter substrate, the TN mode color filter substrate further includes an ITO film for forming a common electrode, which is formed on the substrate on which the color filter layer has been formed. The ITO film is formed on the substrate on which the color filter layer has been formed by a sputtering method.

Therefore, the TN mode color filter substrate includes forming a color filter layer on the substrate; forming a common electrode on the substrate on which the color filter layer has been formed; forming a first organic layer and a second organic layer on the common electrode successively; performing a front exposure and a back exposure on the substrate; forming a spacer and a black matrix by developing the exposed organic layers; and forming an alignment layer on the spacer.

As so far described, in the color filter substrate formation process according to the present invention, after R, G and B sub-color filer layers are formed on a substrate, a black matrix and a column spacer may be formed through one mask process. Accordingly, the color filter substrate may be fabricated with a small number of masks, and productivity may be improved through a simplified fabrication process.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A method for forming a color filter substrate, the method comprising:
forming a color filter layer on a substrate;
forming a first organic layer and a second organic layer on the substrate;
performing front exposure and back exposure of the first and second organic layers on the substrate; and
forming a spacer and a black matrix by developing the exposed organic layers.

2. The method of claim 1, further comprising forming a common electrode on the substrate.

3. The method of claim 1, wherein the color filter layer includes an ultraviolet light absorbent.

4. The method of claim 1, wherein forming the color filter layer comprises:
forming first sub-color filter layers separated from each other on the substrate;
forming second sub-color filter layers separated from the first sub-color filter layers; and
forming third sub-color filter layers separated from both the first and second sub-color filter layers.

5. The method of claim 4, wherein forming the first, second and third sub-color filter layers comprises:
exposing the sub-color filter layers; and
developing the exposed sub-color filter layers.

6. The method of claim 1, wherein the first organic layer is a photosensitive organic layer hardened by back exposure.

7. The method of claim 6, wherein the first organic layer is a negative photoresist.

8. The method of claim 1, wherein the second organic layer is a photosensitive organic layer hardened by exposure.

9. The method of claim 8, wherein the second organic layer is a negative photoresist.

10. The method of claim 1, wherein ultraviolet light is irradiated onto the first and second organic layers in the front exposure and the back exposure.

11. The method of claim 1, wherein the front exposure and the back exposure are performed simultaneously.

12. The method of claim 1, further comprising forming an alignment layer on the spacer.

13. The method of claim 1, wherein the second organic layer is sequentially formed on the first organic layer.

14. The method of claim 1, wherein the front and back exposures are performed at different times.

15. A method for forming multiple layers on a substrate, the method comprising:
forming a plurality of photosensitive layers on the substrate;
exposing the photosensitive layers to light from opposing sides of the substrate; and
developing the photosensitive layers after exposing the photosensitive layers.

16. The method of claim 15, further comprising forming a common electrode on the substrate.

17. The method of claim 15, farther comprising forming a blocking layer on the substrate prior to forming the photosensitive layers, the blocking layer including a material through which the light is not transmitted.

18. The method of claim 17, wherein the blocking layer comprises a plurality of sub-color filter layers separated from each other and formed at different times.

19. The method of claim 17, further comprising forming a common electrode on the the blocking layer.

20. The method of claim 15, wherein the photosensitive layers are simultaneously exposed.

21. The method of claim 15, wherein the photosensitive layers are exposed at different times.

22. The method of claim 15, wherein the photosensitive layers are sequentially formed.

23. The method of claim 15, wherein one of the developed photosensitive layers forms spacers to maintain a cell gap.

24. The method of claim 15, wherein one of the developed photosensitive layers forms a black matrix layer.

25. The method of claim 15, further comprising forming an alignment layer on the substrate after developing the photosensitive layers.

26. The method of claim 15, wherein the photosensitive layers contact each other.

27. The method of claim 26, wherein the photosensitive layers have different widths.

28. The method of claim 27, wherein a first of the photosensitive layers is substantially completely overlapped by a second of the photosensitive layers.

29. A substrate comprising a color filter layer that contains sub-color filter layers, the color filter layer including a blocking material that substantially prevents light of a wavelength smaller than that of a visible range from penetrating the color filter layer.

30. The substrate of claim 29, wherein the blocking material comprises an ultraviolet absorbent.

31. The substrate of claim 29, further comprising a black matrix layer between the sub-color filter layers.

32. The substrate of claim 31, further comprising a spacer on the black matrix layer.

33. The substrate of claim 29, further comprising a common electrode on the color filter layer.

34. The substrate of claim 33, further comprising a black matrix layer between the sub-color filter layers, the common electrode disposed between the black matrix layer and the color filter layer.

35. The substrate of claim 29, further comprising an alignment layer on the color filter layer.
